(19) United States
(12) Patent Application Publication
(10) Pub. No.: US 2007/0005565 A1
(43) Pub. Date: Jan. 4, 2007

(54) Database searching method and apparatus

(75) Inventors: Jong-hoon Jeong, Suwon-si (KR); Geon-hyoung Lee, Hwaseong-si (KR); Chul-woo Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS., LTD.

(21) Appl. No.: 11/389,231

(22) Filed: Mar. 27, 2006

(30) Foreign Application Priority Data
Jul. 4, 2005 (KR) 10-2005-0059716

(51) Int. Cl. G06F 17/30

(52) U.S. Cl. 707/2

(57) ABSTRACT

A database searching method and apparatus for searching database information for a media stored in a multimedia device or data stored in a data processing device, and providing the search result in a sound format. The method includes searching and detecting a database for a data search, transforming the detected database information into a speech signal, and outputting the speech signal as the search result.

### CROSS-REFERENCE TO RELATED PATENT APPLICATION

This application claims priority from Korean Patent Application No. 10-2005-0059716, filed on Jul. 4, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to database searching, and more particularly, to searching for one or more media from a multimedia device or data from a data processing device.

2. Description of the Related Art

The development of high-capacity, low-power consuming, and subminiature storage devices has lead to an increase in storage capacities of mobile multimedia devices such as mobile phones and MPEG Layer-3 (MP3) players. As the storage capacities of mobile multimedia devices have increased, systematic management of multimedia stored in the mobile multimedia devices is required. In general, a multimedia device manages multimedia installed therein, using a database that has a directory-based hierarchical structure.

Thus, a multimedia device that contains a database for multimedia management searches the database for desired media.

Conventionally, when searching a database contained in a multimedia device for one or more media, the multimedia device displays database information, such as that illustrated in FIG. 1, on a display unit such as a liquid crystal display (LCD).

Accordingly, a user must check the database information displayed on a display unit to search the database for desired media. A multimedia device that does not include a display unit cannot display database information and thus cannot be searched for one or more media stored therein. The multimedia device that does not include the display unit can reproduce one or more media stored therein sequentially or in a predetermined order, but cannot select a desired media from the media stored therein and cannot reproduce the selected media.

A data processing apparatus, such as a personal computer (PC), also manages data retained therein using a hierarchical database, and displays database information on a monitor when searching for data. Therefore, a user reads the database information on the monitor to search the database for data from the data processing apparatus.

### SUMMARY OF THE INVENTION

The present invention provides a database searching method and apparatus for providing database information using sound when searching a database for one or more media installed in a multimedia device or when searching for data stored in a data processing device.

The present invention also provides a database searching method and apparatus for searching a database for one or more media stored in a multimedia device that does not include a display unit.

The present invention also provides a database searching method and apparatus for searching a database for one or more media or data stored in a device without visually checking the state of the device.

According to an aspect of the present invention, there is provided a method of searching a database, the method including searching a database for data to be searched and detecting database information of the data to be searched, when a command which controls a data search is received; transforming the detected database information into a speech signal; and outputting the speech signal as a result of searching the database.

The method may further include when a command which searches for data is received, transforming data which is being reproduced or has recently been searched into a speech signal, and outputting the speech signal, wherein the command which controls the data search is input based on the output speech signal.

The method may further include transforming the command which controls the data search into one of a speech signal and a predetermined sound signal, and outputting the transformed signal.

According to another aspect of the present invention, there is provided a method of searching a database in a multimedia device, the method including searching a database for one or more media and detecting database information of the media to be searched, when a command which controls searching for the media installed in the multimedia device is received; transforming the detected database information into a speech signal; and outputting the speech signal as a result of searching the database.

According to another aspect of the present invention, there is provided an apparatus which searches a database, the apparatus including a command input unit which inputs a user command; a storage medium which stores database information for a data search; a database searching controller which receives a command which controls a data search from the command input unit, which searches the storage medium for the database information, and which detects database information of the data to be searched; a text-to-speech unit which transforms the database information detected by the database searching controller into a speech signal; and an output unit which outputs the speech signal received from the text-to-speech unit.

According to another aspect of the present invention, there is provided an apparatus which searches a database, the apparatus including a command input unit which inputs a user command; a storage medium which stores database information for a data search; a database searching controller which reads the database information from the storage medium and which generates and outputs database information when receiving a command, which searches for data, from the command input unit, and detects and outputs database information of data to be searched from the generated database information when receiving a command which controls a data search from the command input unit; a text-to-speech unit which transforms the database information received from the database searching controller into a speech signal; and an output unit which outputs the speech signal received from the text-to-speech unit.

According to another aspect of the present invention, there is provided an apparatus which searches a database in a multimedia device, the apparatus including a command input unit which inputs a user command; a storage medium which stores database information for a media search; a database searching controller which receives a command which controls a media search from the command input unit, which searches the database information stored in the storage medium in response to the received command, and which detects database information of the media to be searched; a text-to-speech unit which transforms the database information received from the database searching controller into a speech signal; and an output unit which outputs the speech signal received from the text-to-speech unit.

### BRIEF DESCRIPTION OF THE DRAWINGS

The above and other aspects of the present invention will become more apparent by describing in detail exemplary embodiments thereof with reference to the attached drawings in which:

FIG. 1 illustrates a conventional hierarchical database display;

FIG. 2 is a block diagram of an apparatus for searching a database according to an exemplary embodiment of the present invention;

FIG. 3 is a block diagram of an apparatus for searching a database according to another exemplary embodiment of the present invention;

FIG. 4 is a block diagram of an apparatus for searching a database according to yet another exemplary embodiment of the present invention;

FIG. 5 is a flowchart illustrating a method of searching a database according to an exemplary embodiment of the present invention;

FIG. 6 is a flowchart illustrating a method of searching a database according to another exemplary embodiment of the present invention;

FIG. 7 is a flowchart illustrating a method of searching a database according to yet another exemplary embodiment of the present invention; and

FIG. 8 is a flowchart illustrating a method of searching a database according to still another exemplary embodiment of the present invention.

### DETAILED DESCRIPTION OF THE EXEMPLARY EMBODIMENTS

Hereinafter, exemplary embodiments of the present invention will be described in detail with reference to the accompanying drawings.

FIG. 2 is a block diagram of an apparatus for searching a database according to an exemplary embodiment of the present invention. The apparatus illustrated in FIG. 2 may be installed in a multimedia device, such as an MP3 player or a mobile phone, or a data processing device such as a PC. Referring to FIG. 2, the apparatus includes a command input unit 201, a database searching controller 202, a storage medium 203, a text-to-speech unit 204, and an output unit 205.

A user command may be input via the command input unit 201. That is, a user may input a command that searches for data/media or a command that controls a data/media search via the command input unit 201. The command that searches for data/media is a request command that sets a device operating mode to a data/media search mode. The command that controls the data/media search is a command that controls the data/media search after setting the device operating mode to the data/media search mode. The medium may be any medium file such as an audio file, a video file, an audio and video file, or a text file.

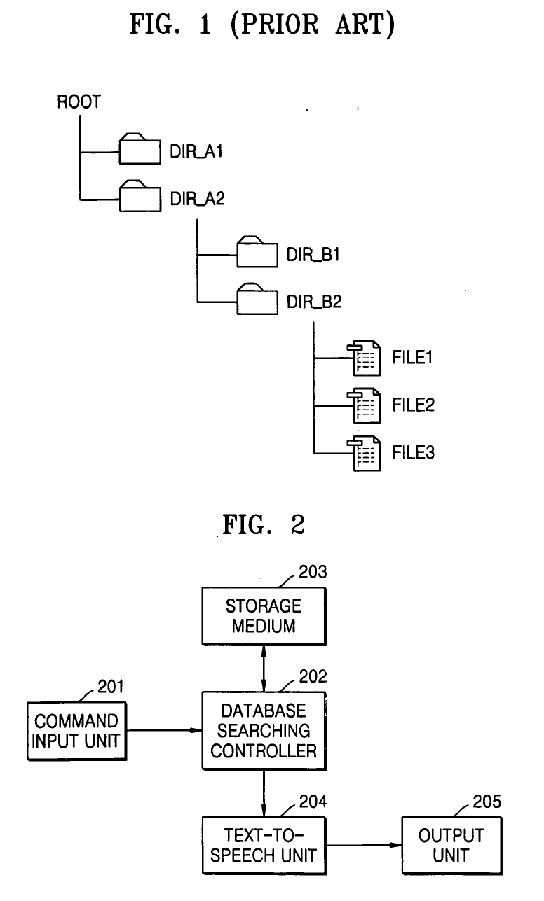

For instance, the command that controls the data/media search may be a command that selects a search direction, e.g., an upper-rank folder, a lower-rank folder, a left folder, or a right folder, so as to search a hierarchical database such as that installed in FIG. 1. The command input unit 201 may include a plurality of function keys.

The database searching controller 202 may be set to be activated in response to the command that searches for data/media received from the command input unit 201. Next, when receiving the command that controls the data/media search from the command input unit 201, the database searching controller 202 searches for database information stored in the storage medium 203 in response to the received command, and detects database information of data to be searched.

For instance, when database information is constructed as illustrated in FIG. 1 and a database is searched previously at a position “DIR_B1”, upon receiving a command that controls a search of a lower-rank folder for data/media from the command input unit 201, the database searching controller 202 detects database information from the database information stored in the storage medium 203 at a position “DIR_B2” by searching a lower-rank folder after the position “DIR_B1”. The detected database information is database information of the data to be searched in response to the command that controls the data/media search.

In this case, the database searching controller 202 may provide the text-to-speech unit 204 with text information corresponding to the command that controls the data/media search, the command being received from the command input unit 201. For instance, when the command that controls the search of “a lower-rank folder” for data/media is provided as described above, the database searching controller 202 provides the text-to-speech unit 204 with text information corresponding to “the lower-rank folder”.

Also, when receiving the command that searches for data/media from the command input unit 201, the database searching controller 202 reads the database information from the storage medium 203 and produces hierarchical database information such as that illustrated in FIG. 1. When receiving the command that controls the data/media search from the command input unit 201, the database searching controller 202 detects database information of data, which is to be searched, from the produced database information in response to the received command.

The database searching controller 202 stores either database information of a medium from which data is being reproduced or data that is being reproduced, or database information of a medium or data that has recently been searched, and outputs the stored database information to the text-to-speech unit 204 upon receiving the command that searches for data/media from the command input unit 201.

The database searching controller 202 may decide and store the database information of the media from which data is being reproduced or the data that is being reproduced, based on reproduction information received from a central control unit (not shown) of a related multimedia device/data processing device. The database information of the medium or the data that has recently been searched has previously been searched by the database searching controller 202, that is, it was stored in the database searching controller 202 before transmitting the searched database information to the text-to-speech unit 204.

The database information searched by the database searching controller 202 is output to the text-to-speech unit 204. The searched database information has a text format.

The storage medium 203 stores database information available for a data/media search.

The text-to-speech unit 204 transforms the database information searched by the database searching controller 202 into a speech signal. In detail, the text-to-speech unit 204 combines the text information in basic language units to generate and output the speech signal. The basic language units may be phonemes. The speech signal output from the text-to-speech unit 204 is transmitted to the output unit 205.

Similarly, upon receiving text information corresponding to a command that controls a medium search from the database searching controller 202, the text-to-speech unit 204 may combine the text information to generate and output a speech signal. Alternatively, the text-to-speech unit 204 may output a predetermined sound signal with a specific beat.

The output unit 205 outputs the speech signal, which is received from the text-to-speech unit 204, in a form that a user can comprehend. Therefore, the output unit 205 may be an audio data output unit that includes components such as a speaker and an amplifier.

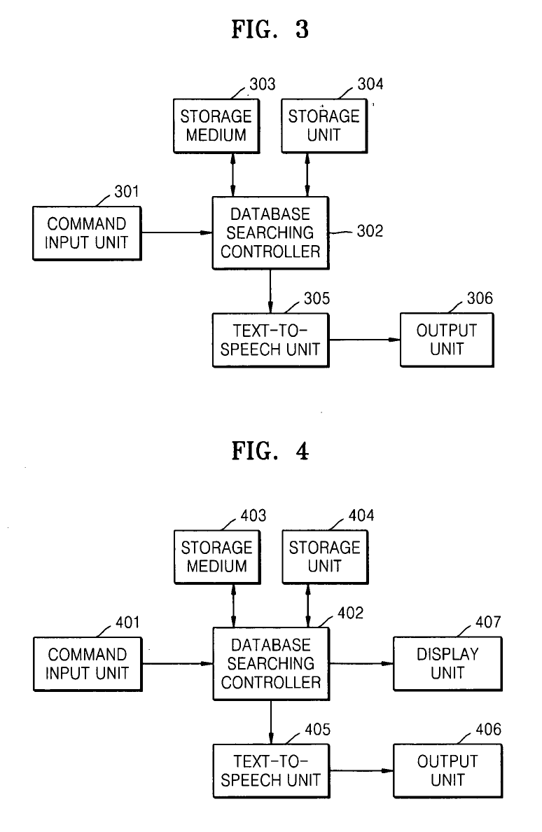

FIG. 3 is a block diagram of an apparatus for searching a database according to another exemplary embodiment of the present invention. The apparatus of FIG. 3 may be installed in a multimedia device, such as an MP3 player or a mobile phone, or a data processing device such as a PC. Referring to FIG. 3, the apparatus includes a command input unit 301, a database searching controller 302, a storage medium 303, a storage unit 304, a text-to-speech unit 305, and an output unit 306.

Operations of the command input unit 301, the storage medium 303, the text-to-speech unit 305, and the output unit 306 are similar to those of the command input unit 201, the storage medium 203, the text-to-speech unit 204, and the output unit 205, illustrated in FIG. 2.

Upon receiving a command that searches for data/media, the database searching controller 302 reads from the storage unit 304 either database information of a media from which data is being reproduced or data that is being reproduced, or database information of a medium or data that has recently been searched, and provides the read database information to the text-to-speech unit 305.

Then, a speech signal corresponding to the read database information is sequentially output via the text-to-speech unit 305 and the output unit 306, and a user inputs the command that controls the data/media search, based on the speech signal.

As described with reference to FIG. 2, the database searching controller 302 may read the database information from the storage medium 303 and generate database information such as that shown in FIG. 1.

Upon receiving a command that controls searching for data/media from the command input unit 301, the database searching controller 302 detects database information of data or a medium to be searched, based on the generated database information or the database information stored in the storage medium 303, and outputs the detected database information to the text-to-speech unit 305.

In this case, like the database searching controller 202 shown in FIG. 2, the database searching controller 302 may provide the text-to-speech unit 305 with text information corresponding to the command that controls searching for a medium.

As described above with reference to FIG. 2, the database searching controller 302 may decide the database information of the medium from which data is being reproduced or the data that is being reproduced based on reproduction information provided by a central controller unit, and store it in the storage unit 304.

Also, as described above with reference to FIG. 2, the database information of the medium or the data that has recently been searched, which is stored in the storage unit 304, has previously been searched by the database searching controller 302, that is, it was stored in the storage unit 304 or updated before the database searching controller 302 detects the database information and transmits it to the text-to-speech unit 305.

The storage medium 303 and the storage unit 304 may be realized as a single storage medium.

FIG. 4 is a block diagram of an apparatus for searching a database according to yet another exemplary embodiment of the present invention. The apparatus of FIG. 4 may be installed in a multimedia device, such as an MP3 player or a mobile phone, or a data processing device such as a PC. Referring to FIG. 4, the apparatus includes a command input unit 401, a database searching controller 402, a storage medium 403, a storage unit 404, a text-to-speech unit 405, an output unit 406, and a display unit 407.

Constructions and operations of the command input unit 401, the database searching controller 402, the storage medium 403, the storage unit 404, the text-to-speech unit 405, the output unit 406, are similar to those of the command input unit 301, the database searching controller 302, the storage medium 303, the storage unit 304, the text-to-speech unit 305, and the output unit 306, illustrated in FIG. 3.

Although the operation of the database searching controller 402 is similar to that of the database searching controller 302, the database searching controller 402 differs from the database searching controller 302 in that database information stored in the storage medium 403 is output to the display unit 407. That is, in response to a command that searches for data/media, the database searching controller 402 reads the database information from the storage medium 403, produces database information such as that illustrated in FIG. 1, and displays it on the display unit 407.

Accordingly, a user may search for database information based on database information either obtained from a speech signal or displayed on the display unit 407. In this case, when database information is searched in response to a command that controls a data/media search, provided from the command input unit 401, the database searching controller 402 may display the searched database information on the display unit 407.

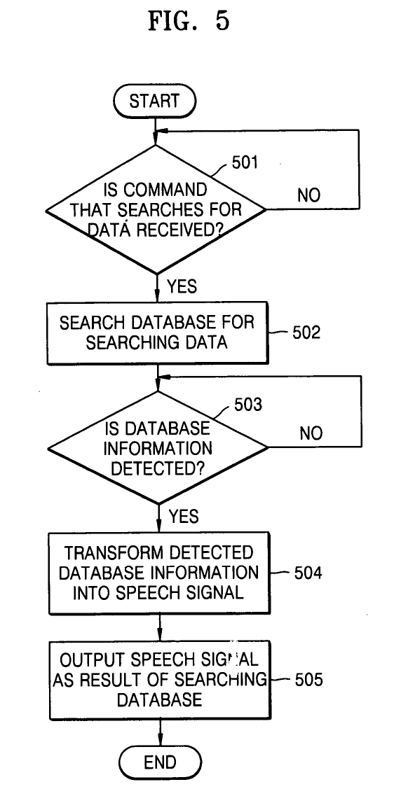

FIG. 5 is a flowchart illustrating a method of searching a database in a data processing device, according to an exemplary embodiment of the present invention. The method of FIG. 5 will now be described with reference to FIG. 2.

Referring to FIG. 5, when receiving a command that controls a data search from the command input unit 201, the database searching controller 202 searches the storage medium 203 for a database for the data search in order to detect database information of data to be searched (operations 501 through 503).

The database searching controller 202 transmits the detected database information to the text-to-speech unit 204 to transform the detected database information into a speech signal (operation 504). That is, the text-to-speech unit 204 combines the database information in a text format in basic language units to obtain the speech signal.

The database information that is transformed into the speech signal by the text-to-speech unit 204 is output as a result of searching the database via the output unit 205 (operation 505).

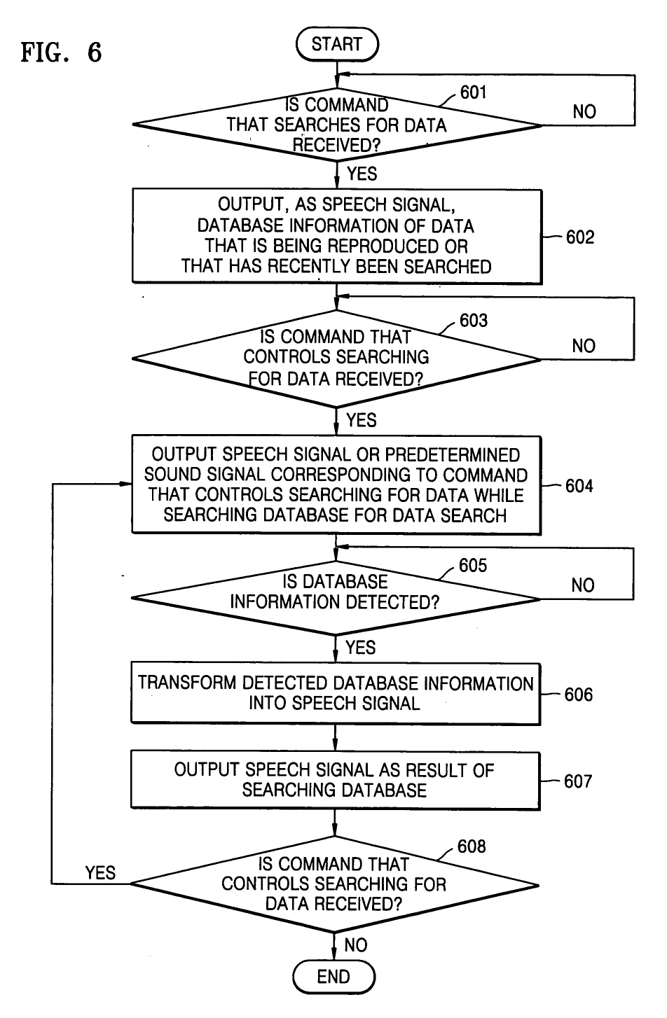

FIG. 6 is a flowchart illustrating a method of searching a database in a data processing device, according to another exemplary embodiment of the present invention. The method of FIG. 6 will now be described with reference to FIG. 3.

First, when receiving a command that searches for data from the command input unit 301, the database searching controller 302 outputs to the text-to-speech unit 305 database information of data that is being reproduced or that has recently been searched, and the text-to-speech unit 305 outputs the database information as a speech signal (operations 601 and 602).

When receiving a command that controls a data search from the command input unit 301, the database searching controller 302 outputs text information corresponding to the received command to the text-to-speech unit 305 to obtain a speech signal corresponding to the received command or a predetermined sound signal, such as a specific beat signal, while searching the storage medium 303 for a database for a data search (operations 603 and 604).

Next, when database information of the data to be searched is detected from a database search, the database searching controller 302 outputs the detected database information to the text-to-speech unit 305 to transform it into a speech signal (operations 605 and 606). The speech signal is output as a result of searching the database via the output unit 306 (operation 607).

Next, the database searching controller 302 checks whether the command is received again from the command input unit 301 (operation 608). If the command is received again, the method returns to operation 604 to be performed by the database searching controller 302. If not, the database searching controller 302 ends the method.

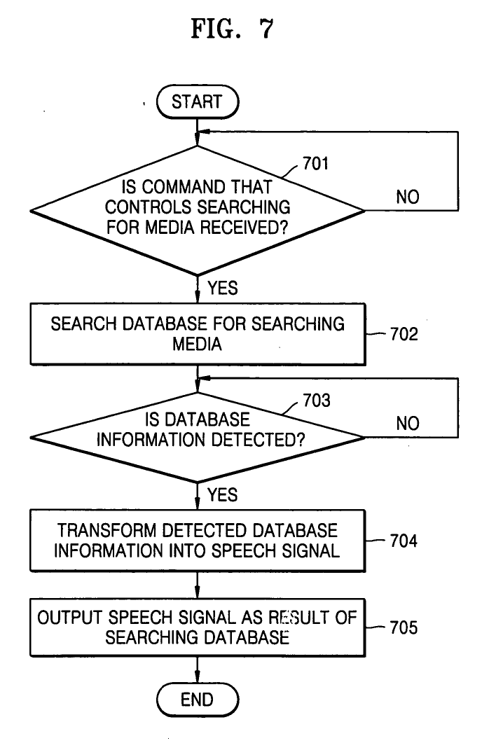

FIG. 7 is a flowchart illustrating a method of searching for a database in a multimedia device, according to yet another exemplary embodiment of the present invention. The method of FIG. 7 will now be described with reference to FIG. 2.

First, when receiving a command that controls searching for a medium from the command input unit 201, the database searching controller 202 searches the storage medium 203 for a database for a media search to detect database information of a medium to be searched (operations 701 through 703).

Next, the database searching controller 202 transmits the detected database information to the text-to-speech unit 204 to transform the detected database information into a speech signal (operation 704). That is, the text-to-speech unit 204 combines the database information in a text format in basic language units to generate the speech signal.

Next, the database information, which is transformed into the speech signal by the text-to-speech unit 204, is output as a result of searching the database via the output unit 205 (operation 705).

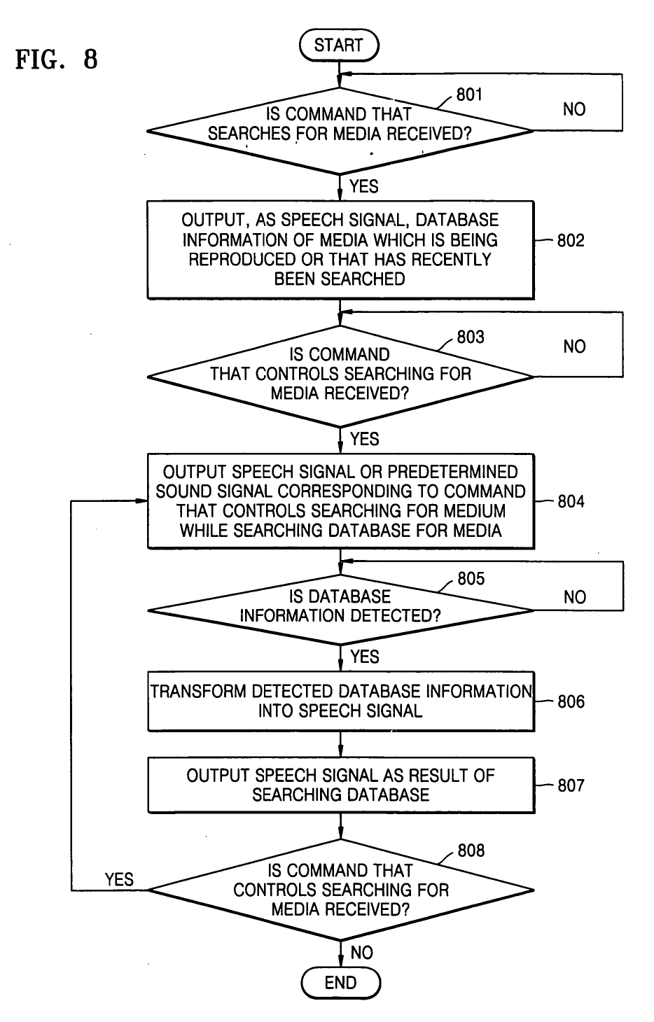

FIG. 8 is a flowchart illustrating a method of searching a database in a multimedia device, according to still another exemplary embodiment of the present invention. The method of FIG. 8 will now be described with reference to FIG. 3.

First, when receiving a command that searches for a medium from the command input unit 301, the database searching controller 302 provides the text-to-speech unit 305 with database information of a medium from which data is being reproduced or that has recently been searched so as to obtain a speech signal (operations 801 and 802).

Next, when receiving a command that controls a medium search from the command input unit 301, the database searching controller 302 outputs text information corresponding to the received command to the text-to-speech unit 305 so as to obtain a speech signal corresponding to the received command or a predetermined sound signal, such as a specific beat signal, while searching the storage medium 303 for a database for the media search (operations 803 and 804).

Next, when database information of the medium to be searched is detected, the database searching controller 302 outputs the detected database information to the text-to-speech unit 305 to transform the detected database information into a speech signal (operations 805 and 806). The speech signal is output as a result of searching the database via the output unit 306 (operation 807).

Next, the database searching controller 302 checks whether the command is received again from the command input unit 301. If the command is received again, the method returns to operation 804 to be performed by the database searching controller 302. If not, the database searching controller 302 ends the method (operation 808).

A program that executes a method of searching a database according to an exemplary embodiment of the present invention can be embodied as computer readable code in a computer readable medium. Here, the computer readable medium may be any recording apparatus capable of storing data that is read by a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as computer readable code in the distributed system.

As described above, according to the exemplary embodiment of the present invention, when searching a database for a media search in a multimedia device or a database for a data search in a data processing device, the search result is provided in the form of sound. Accordingly, it is possible to allow even a device that does not include a display unit to search a database for a media/data search to select and reproduce desired data/media. Also, it is possible to search a database for a medium installed or data stored in a device in different situations, such as while driving a vehicle, when it is difficult to visually determine the state of the device.

According to the exemplary embodiment of the present invention, by providing the search result in the form of sound, it is possible to increase the performance of a multimedia device or a data processing device designed for visually handicapped persons or those who are not accustomed to the construction of displayed database information.

Furthermore, the need to store speech signals corresponding to database information to be searched beforehand is removed by providing a search result using a text-to-speech unit. Therefore, if the database information to be searched is updated, updating of speech signals corresponding to the updated database information is not required.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of searching a database comprising:
searching a database for data and detecting database information of the data to be searched, if a command which controls a data search is received;
transforming the detected database information into a speech signal; and
outputting the speech signal.

2. The method of claim 1, further comprising, if a command which searches for the data is received, transforming data which is being reproduced or has recently been searched, into a speech signal, and outputting the speech signal,
wherein the command which controls the searching the database is input based on the output speech signal.

3. The method of claim 2, further comprising transforming the command which controls the data search into one of a speech signal and a predetermined sound signal, and outputting the one of the speech signal and the predetermined sound signal.

4. The method of claim 1, further comprising transforming the command which controls the searching the database into one of a speech signal and a predetermined sound signal, and outputting the one of the speech signal and the predetermined sound signal.

5. A method of searching a database in a multimedia device, comprising:
searching a database for at least one media and detecting database information of the media to be searched, if a command which controls searching for the media installed in the multimedia device is received;
transforming the detected database information into a speech signal; and
outputting the speech signal.

6. The method of claim 5, further comprising, if a command which searches for the media is received, transforming database information of a media which is being reproduced or which has recently been searched into a speech signal, and outputting the speech signal,
wherein the command which controls searching for the media is input based on the output speech signal.

7. The method of claim 6, further comprising transforming the command which controls searching for the media into one of a speech signal and a predetermined sound signal, and outputting the one of the speech signal and the predetermined sound signal.

8. The method of claim 5, further comprising transforming the command which searches for the media into one of a speech signal and a predetermined sound signal, and outputting the one of the speech signal and the predetermined sound signal.

9. An apparatus which searches a database, the apparatus comprising:
a command input unit which inputs a user command;
a storage medium which stores database information for a data search;
a database searching controller which receives a command which controls a data search from the command input unit, searches the storage medium for the database information, and detects database information of the data to be searched;
a text-to-speech unit which transforms the database information detected by the database searching controller into a speech signal; and
an output unit which outputs the speech signal received from the text-to-speech unit.

10. An apparatus which searches a database, the apparatus comprising:
a command input unit which inputs a user command;
a storage medium which stores database information for a data search;
a database searching controller which reads the database information from the storage medium and generates and outputs the database information if a command which searches for data is received from the command input unit, and detects and outputs database information of the data to be searched from the generated database information if receiving a command, which controls a data search, from the command input unit;
a text-to-speech unit which transforms the database information received from the database searching controller into a speech signal; and
an output unit which outputs the speech signal received from the text-to-speech unit.

11. An apparatus which searches a database in a multimedia device, the apparatus comprising:
a command input unit which inputs a user command;
a storage medium which stores database information for a media search;
a database searching controller which receives the command which controls the media search from the command input unit, searches the database information stored in the storage medium in response to the received command, and which detects database information of the media to be searched;
a text-to-speech unit which transforms the database information received from the database searching controller into a speech signal; and
an output unit which outputs the speech signal received from the text-to-speech unit.

12. The apparatus of claim 11, further comprising a storage unit which stores database information of a media which is being reproduced or which has recently been searched,
wherein if receiving the command which searches for the media from the command input unit, the database searching controller reads from the storage unit the database information of the media which is being reproduced or which has recently been searched, and outputs the read database information to the text-to-speech unit.

13. The apparatus of claim 12, wherein the database searching controller transmits information corresponding to the received command, which controls the media search, to the text-to-speech unit, and
wherein the text-to-speech unit transforms the received information into one of a speech signal and a predetermined sound signal and outputs the one of the speech signal and the predetermined sound signal.

14. The apparatus of claim 11, wherein the database searching controller stores the database information of the media which is being reproduced or which has recently been searched, and outputs the stored database information to the text-to-speech unit if receiving the command, which searches for the media, from the command input unit.

15. The apparatus of claim 14, wherein the database searching controller transmits the information corresponding to the command, which controls searching for the media, to the text-to-speech unit, and
wherein the text-to-speech unit transforms the received information into one of a speech signal and a predetermined sound signal and outputs the one of the speech signal and the predetermined sound signal.

16. The apparatus of claim 11, wherein the database searching controller transmits the information corresponding to the command, which controls searching for the media, to the text-to-speech unit, and
wherein the text-to-speech unit transforms the received information into one of a speech signal and a predetermined sound signal and outputs the one of the speech signal the predetermined sound signal.
